(19) United States
(12) Patent Application Publication
(10) Pub. No.: US 2022/0330745 A1
(43) Pub. Date: Oct. 20, 2022

(54) METHOD AND APPARATUS FOR OVER ICE BREWING

(71) Applicant: Keurig Green Mountain, Inc, Burlington, MA (US)

(72) Inventors: Robert Holmes, Berlin, MA (US); Joseph George Fucci, Amherst, NH (US); Christopher Godfrey, Rowley, MA (US)

(73) Assignee: Keurig Green Mountain, Inc, Burlington, MA (US)

(21) Appl. No.: 17/640,227

(22) PCT Filed: Sep. 17, 2020
(86) PCT No.: PCT/US2020/051238

§ 371 Date: Mar. 3, 2022

Related U.S. Application Data
(60) Provisional application No. 62/903,309, filed on Sep. 20, 2019.

(51) Int. Cl. A47J 31/52; A47J 31/46

(52) U.S. Cl. CPC A47J 31/5255; A47J 31/5253; A47J 31/468

(57) ABSTRACT

A beverage forming method and system arranged to allow a user to adjust a volume and flow rate of liquid provided to a brew chamber so that a dispensed beverage is suitable for mixing with ice, e.g., to form an iced coffee beverage. In some cases, a user may provide input indicating that an iced beverage should be dispensed during a beverage dispensing operation. For example, after a dispensing operation is started to dispense a beverage having a particular volume, a user can adjust the beverage volume to be smaller and suitable for mixing with ice.

### CROSS REFERENCE TO RELATED APPLICATION

This application claims the benefit of U.S. Provisional Application No. 62/903,309, filed Sep. 20, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Patent Application publication 2008/0134902 discloses a beverage forming system that heats water in a reservoir and pneumatically delivers the heated water to a brew chamber for making a coffee drink or other beverage. U.S. Pat. No. 7,398,726 discloses another beverage forming system that delivers heated water from a dispensing tank to a brew chamber by pneumatic forcing of the water from the metering tank. U.S. Patent Application publications 2009/0120299 and 2008/0092746, and U.S. Pat. Nos. 3,511,166, 3,958,502, 4,602,145, 4,263,498 and 8,037,811 disclose other system types in which water in a heater tank or heat exchanger is forced to flow out of the tank and to a beverage making station by introducing unheated water into the tank/exchanger.

### SUMMARY

Some aspects of the invention relate to arrangements for allowing a user to adjust, directly or indirectly, one or more brew parameters so as to cause a beverage machine to dispense a beverage suitable for mixing with ice as part of an automated dispensing operation. Beverage machines are normally arranged to dispense beverages that are intended for drinking exactly as dispensed without adding any other materials, or with the addition of a relatively small amount of other material, such as creamer, sugar, milk, etc. In one specific example, a beverage machine may be normally arranged to combine water and coffee grounds to dispense a coffee beverage intended to be consumed “black” (without any additional materials), or combined with relatively small amounts of other materials. Such beverages typically are not desirably combined with ice, e.g., to form an iced beverage, particularly in the case of beverages that are dispensed hot or otherwise at warm temperatures, because the ice dilutes the beverage and makes the diluted beverage taste weak. In some inventive embodiments, a user may provide input to a beverage machine indicating the desire to dispense a beverage that is intended to be mixed with ice, e.g., to form an iced coffee beverage, and in response the beverage machine may reduce a volume of liquid used to mix with beverage ingredients and/or a flow rate of liquid provided for mixing with beverage ingredients to form the dispensed beverage. Such an adjustment in operation by the beverage machine may produce a suitably concentrated dispensed beverage that forms a proper tasting beverage when mixed with ice.

In some cases, a user may define a final volume for a desired iced beverage, e.g., 12 ounces, and the beverage machine may adjust a volume of liquid mixed with beverage material to produce a dispensed beverage that, after mixing with ice and subsequent dilution, has the final volume desired by the user. For example, to produce an iced coffee beverage of 12 ounces (including a mixture of chilled coffee beverage and solid ice at a temperature of about 32 degrees F.), a beverage machine may dispense a hot coffee beverage having a volume of 8 ounces that is formed by mixing hot water and coffee grounds. After the 8 ounces of hot coffee beverage are mixed with ice, the melted ice water and cooled coffee beverage will generally have a final volume of 12 ounces. To make such a selection, the user may press a button on a user interface that represents a final beverage volume of 12 ounces (or other desired volume) along with a button that indicates an “iced” beverage is desired. The beverage machine may dispense the hot coffee beverage (in this example, 8 ounces of hot coffee beverage) into a user supplied cup or other container holding ice. Alternately, the beverage machine may dispense ice into a user's cup as well as dispense hot beverage into the cup, or the beverage machine may form the hot coffee beverage, mix the hot beverage with ice, and then dispense the chilled and diluted beverage (with or without ice) into the user's cup.

In some embodiments, a user may indicate a desire to form an iced beverage to the beverage machine after dispensing operation has been started, and in response the beverage machine may adjust its operation to the formation of an iced beverage. For example, a user may initially select a particular beverage volume, such as 8 ounces, and the beverage machine may begin operation to dispense a hot beverage having an 8 ounce volume. After the brew cycle (or dispensing operation) has started, the user may indicate a desire to form an iced beverage for the brew cycle, e.g., by pressing an “iced beverage” button on the machine. In response, the beverage machine may adjust its operation, e.g., reducing a flow rate of water delivered to a brew chamber to achieve a higher concentration for the dispensed beverage. In some cases the beverage machine may adjust a volume of water used to form the dispensed beverage, e.g., the beverage machine may interpret the 8 ounce volume selection and “iced” indication as meaning an iced beverage having a finished or final volume of 8 ounces is desired. In this example, the beverage machine may dispense 5 ounces of hot beverage for mixing with ice that produces a finished or final beverage volume of 8 ounces after dilution with the melted ice water. Alternately, the beverage machine may dispense 8 ounces of more highly concentrated beverage for mixing with ice to form an iced beverage having a finished or final volume of more than 8 ounces. A temperature of the dispensed beverage may be adjusted as well. For example, a “hot” beverage may be dispensed at a particular temperature, but if that beverage is to be dispensed for an “iced” beverage, the beverage may be dispensed at a lower temperature, e.g., the beverage may be formed with unheated water or water that is heated to a lesser extent. In some cases, in addition to indicating a desire to form an iced beverage during a brew cycle, the user may select a beverage volume too. For example, a user may depress an “iced beverage” button and change the dispensed volume to something different from what was originally indicated. Aspects of the invention allow a user to make a change to a dispensed volume of a beverage during the dispensing process, and/or can allow the user to make changes to other brew parameters during a dispensing operation, such as beverage strength, dispense time, brew temperature, air purge (or not), and others.

In one aspect of the invention, a beverage forming system includes a liquid supply arranged to provide a liquid for forming a beverage. As an example, a liquid supply may include a water storage tank or reservoir, a pump to move water, conduits to carry the flow of water or other liquid, flow meters and/or other sensors to detect liquid, valves for controlling flow, etc. A brew chamber may be arranged to hold a beverage material for mixing with the liquid to form a beverage, e.g., the brew chamber may hold a beverage cartridge that contains a beverage material such as coffee grounds that form a coffee beverage when mixed with water. A liquid conditioner may be arranged to heat and/or cool the liquid that is provided to, and/or dispensed from, the brew chamber, e.g., may include a heater tank or inline heater including an electrical resistance heater, or a refrigeration system arranged to cool a liquid. A control circuit may be arranged to control the liquid supply and the liquid conditioner to operate automatically according to one or more brew parameters during a dispensing operation to deliver heated or cooled liquid to the brew chamber to form the beverage. For example, the control circuit may set a beverage volume and temperature prior to beginning a dispensing operation (which may or may not be in response to user input), and then automatically control portions of the beverage system to operate according to the set brew parameters once the dispensing operation begins.

However, the control circuit may be arranged to change at least one of the brew parameters based on user input indicating that the dispensed beverage is to be mixed with ice. Such input indicating a desire for an iced beverage may be received prior to, or during the dispensing operation and cause the liquid supply or liquid conditioner to change operation based on at least one changed brew parameter. For example, a user may indicate that an iced beverage is to be formed, and the control circuit may control the liquid supply to provide liquid to the brew chamber to form a beverage having a volume equal to or less than a threshold volume and/or to provide the liquid at a flow rate less than a threshold flow rate and/or to provide the liquid at a temperature less than a threshold temperature. In some embodiments, the threshold volume may be a maximum volume (such as 12 ounces), or an indicated beverage volume at a start of the dispensing operation (e.g., that reflects a final beverage volume after the dispensed beverage is mixed with ice). For example, at the start of a dispensing operation, the user may select a final beverage volume of 12 ounces along with indicating an iced beverage is to be made by combining the dispensed beverage with ice. The control circuit may dispense a beverage volume that is less than the threshold (in this case, final) 12 ounce volume, e.g., 8 ounces, since the dispensed beverage may be hot and melt ice that it is mixed with so that the combined volume of dispensed beverage and melt water is about 12 ounces. In cases where the threshold volume is a maximum volume, the control circuit may cause liquid to be delivered to the brew chamber so that the beverage dispensed has a volume no more than the maximum volume, e.g., which has been determined to be a suitable volume to allow for dilution with melted ice water while still forming a suitably good tasting beverage. The threshold flow rate may be a standard flow rate used to produce a normal strength beverage, e.g., standard or normal strength coffee. The lowered flow rate used for an iced beverage may produce a stronger brew, which results in a proper strength beverage when mixed with ice that melts. The threshold temperature may be a standard temperature used to produce a “hot” coffee beverage. A lowered temperature may be one that is above ambient temperature, e.g., to ensure proper dissolution of coffee materials or other beverage ingredients, but lower than a typical hot beverage (e.g., below 185 degrees F.). In some cases, a beverage may be formed using liquid at two or more different temperatures during the brewing process. For example, a first higher temperature may be used initially (e.g., to put desired coffee ground material into solution), followed by a second lower temperature such that the dispensed beverage is provided at a relatively low temperature and tends to melt ice to a lesser extent. In some cases, a beverage may be formed by delivering liquid at two or more different flow rates during the brewing process. For example, a first slower flow rate may be used initially, followed by a second faster flow rate. In some cases, a combination of brew parameters may change during the brewing process. For example, a first higher temperature and a first slower flow rate may be used initially, followed by a second lower temperature and a second faster flow rate.

The user may provide information to the control circuit to indicate an iced beverage is to be formed via a user interface, which may include one or more buttons, touch screen icons or other elements, or other interface devices that are associated with one or more brew parameters. For example, the user interface may include a plurality of buttons, each of the plurality of buttons associated with a corresponding finished beverage volume and being actuatable by a user to provide the user input. The user interface may also include an “iced” beverage button that may be pressed by a user. Thus, a user may select a beverage volume, such as 12 ounces, and select an iced beverage is to be produced. In response, the beverage machine may dispense a beverage volume (e.g., 8 ounces) that is less than the threshold volume selected by the user (e.g., 12 ounces) because once the dispensed volume is combined with melted ice water the final beverage will have the threshold or final volume. In another example, the beverage machine may employ a flow rate of liquid delivered to the brew chamber during beverage formation that is less than a normal or threshold flow rate, e.g., the lower flow rate may produce a dispensed beverage that has a level of total dissolved solids that is typically not found suitable for most consumers. However, since the dispensed beverage will be mixed with ice, which will melt and dilute the dispensed beverage, the final iced beverage will have a suitable level of total dissolved solids.

In addition to, or alternately to using a volume of liquid to produce a dispensed volume less than a threshold volume or using a flow rate less than a threshold flow rate, the control circuit may be arranged to control or adjust other brew parameters in response to the user's input to form an iced beverage. For example, the control circuit may control the liquid supply or the liquid conditioner to provide liquid at a first temperature during a first portion of a dispensing operation and to provide liquid at a second temperature different from the first temperature during a second portion of the dispensing operation that is after the first portion in response to a user's input indicating the beverage is to be combined with ice. The second temperature may be lower than the first temperature and may aid in dispensing a cooler beverage that is more suitable to mixing with ice. In other embodiments, a temperature of the dispensed beverage, an amount of whipping of the beverage, a time period over which the beverage is dispensed, a speed at which the beverage is dispensed, a pressure of liquid delivered to the brew chamber, and/or an amount of air or steam delivered to purge the brew chamber may be adjusted in response to an indication to form an iced beverage. As mentioned above, the control circuit may be arranged to change one or more brew parameters based on user input received while beverage is being dispensed from the brew chamber, or otherwise during a dispensing operation or brew cycle, e.g., after a user presses a “brew cycle start” button.

In some embodiments, the control circuit may control the liquid supply or the liquid conditioner to provide liquid at a first flow rate during a first portion of a dispensing operation and to provide liquid at a second flow rate different from the first flow rate during a second portion of the dispensing operation that is after the first portion in response to a user's input indicating the beverage is to be combined with ice. The second flow rate may be higher than the first flow rate.

In some embodiments, the control circuit may be arranged to control or adjust a combination of brew parameters in response to the user's input to form an iced beverage. For example, the control circuit may control the liquid supply or the liquid conditioner to provide liquid at a first temperature and a first flow rate during a first portion of a dispensing operation and to provide liquid at a second temperature different from the first temperature and a second flow rate different from the first flow rate during a second portion of the dispensing operation that is after the first portion in response to a user's input indicating the beverage is to be combined with ice. In some embodiments, the second temperature may be lower than the first temperature, and the second flow rate may be higher than the first temperature.

In some cases, user input regarding the formation of an iced beverage may be provided in ways other than via a user interface. For example, the control circuit may include a sensor arranged to detect a characteristic of a beverage material in the brew chamber, such as by reading a barcode or other indicia on a beverage cartridge. The indicia may directly or indirectly indicate that an iced beverage is to be formed, and the control circuit may adjust operation accordingly. For example, the control circuit may be arranged to control the liquid supply to provide liquid to the brew chamber to form a beverage having a volume equal to or less than the threshold volume and/or to provide the liquid at a flow rate less than the threshold flow rate in response to the detected characteristic of the beverage material. In some cases, the threshold volume and/or threshold flow rate may be determined based on the indicia read from the cartridge.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a right side perspective view of a beverage forming system in an illustrative embodiment;

FIG. 2 is a left side perspective view of the beverage forming system with a cartridge holder in an open position; and

FIG. 3 shows a schematic diagram of functional components of the beverage forming system in an illustrative embodiment.

### DETAILED DESCRIPTION

It should be understood that aspects of the invention are described herein with reference to certain illustrative embodiment and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

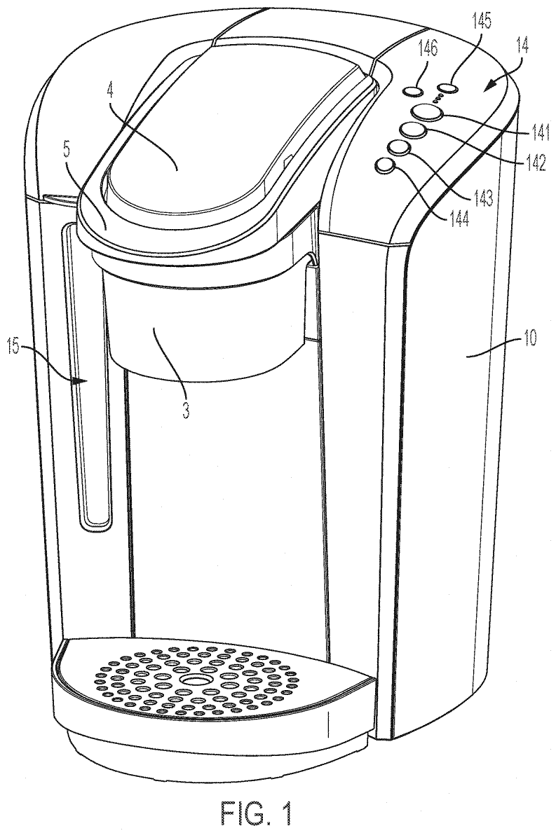

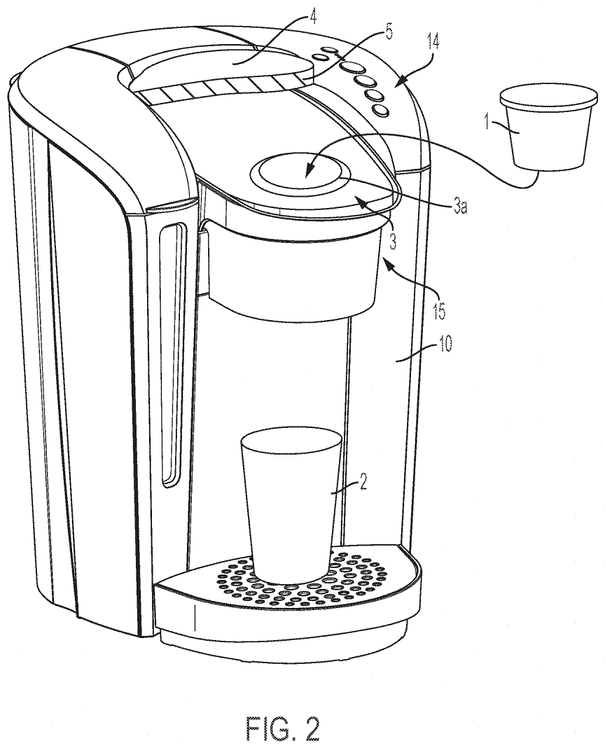

FIGS. 1 and 2 show perspective views of a beverage forming system 100. Although the beverage forming system 100 may be used to form any suitable beverage, such as tea, coffee, other infusion-type beverages, beverages formed from a liquid or powdered concentrate, soups, juices or other beverages made from dried materials, or other, in this illustrative embodiment, the system 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber 15 that includes a cartridge holder 3 and cover 4 of the beverage forming system 100. For example, the holder 3 may be or include a circular, cup-shaped or otherwise suitably shaped opening 3a in which the cartridge 1 may be placed. In this embodiment, the cartridge holder 3 includes an opening 3a that is arranged to receive the cartridge 1. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the opening 3a, e.g., to at least partially enclose the cartridge 1 in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the invention may be employed with any suitably arranged system 100, including drip-type coffee brewers, carbonated beverage machines, and other systems that deliver water to form a beverage. Thus, a cartridge 1 need not necessarily be used, but instead the brew chamber may accept loose coffee grounds or other beverage material to make a beverage. Also, the brew chamber 15 need not necessarily include a cartridge holder 3 and a cover 4. For example, the brew chamber may include a filter basket that is accessible to provide beverage material, and the filter basket itself may be movable, e.g., by sliding engagement with the beverage machine 10 housing, and a cover 4 may be fixed in place. In other embodiments, the brew chamber need not be user accessible, but instead beverage material may be automatically provided to, and removed from, the brew chamber. Accordingly, a wide variety of different types and configurations for a brew chamber may be employed with aspects of the invention.

In accordance with an aspect of the invention, a user may be able to change, directly or indirectly, one or more brew parameters used to form a beverage by the beverage machine so that an iced beverage may be formed. For example, a user may press a button or otherwise indicate a desire to form an iced beverage, and in response the beverage machine may adjust one or more brew parameters to enable formation of an iced beverage. In one embodiment, in response to receipt of a user's indication to form an iced beverage, the beverage machine may reduce a volume of water or other liquid used to form the beverage and/or reduce a flow rate of liquid provided to beverage material (such as coffee grounds) relative to a threshold volume or flow rate. Liquid volume reduction and/or flow rate reduction may help increase a concentration of a dispensed beverage, which may help provide a less diluted tasting beverage after mixing the beverage with ice. Other parameter adjustments may be made as well, or alternately, such as increasing or decreasing a temperature and/or pressure of liquid used in the beverage making process (hotter water and/or water under higher pressure may help extract move flavor components from a beverage material; lower temperature water may help reduce the final beverage temperature and melt ice to a lesser degree). Other beverage production parameters may be adjusted, such as employing a beverage material pre-wetting process, or pulsed or intermittent liquid delivery (both of which are types of flow rate adjustments), beverage material agitation during mixing with precursor liquid, exposing the beverage material to sonic or other energy to aid in extraction, etc.

In the illustrative embodiment of FIGS. 1 and 2, the beverage machine 10 includes a user interface 14 that can display information to, and receive commands or other information from, a user (e.g., via light display, button illumination color or pattern, an alphanumeric text or graphics display, touch screen, etc.). In this illustrative embodiment, the user interface 14 includes four buttons that a user can press to select a beverage volume, 12 oz. button 141, 10 oz. button 142, 8 oz. button 143, and 6 oz. button 144. (This and other examples herein are merely that—examples to illustrate aspects of the invention in one embodiment. The particular buttons in this embodiment may be associated with other beverage volumes or other brew parameters such as those identified above. Also, other user interface devices than buttons may be employed by the user interface 14 to receive user input on beverage volume or any other parameter. For example, the user interface 14 may include “+” and “−” buttons by which a user can increase or decrease a displayed beverage volume, thereby setting the volume to be dispensed. In other embodiments, the user interface 14 may be provided on a remote device, such as a user's smartphone or other computing device, and the user may interact with the user interface 14 to provide input to the controller.) Normally, if a user presses one of the volume buttons 141-144 and instructs or allows the beverage machine 10 to dispense a beverage, the volume of the dispensed beverage will be equal to the volume selected by one of the buttons 141-144.

In this example, the user interface 14 also includes an “iced” button 146 that a user can press to indicate a desire to form an iced beverage. As discussed above, the iced button 146 may be pressed by a user at different times, such as before a brew cycle is begun or afterwards. For example, in preparation for brewing a beverage, a user may place beverage material (e.g., in a single-use or reusable cartridge 1) in the brew chamber 15 (formed by the cartridge holder 3 and the cover 4 in this embodiment), close the brew chamber 15 (if required) and press the iced button 146 to indicate the desire to form an iced beverage. In some embodiments, the beverage machine may immediately start a brew cycle to dispense a beverage without further input from the user. For example, the beverage machine 10 control liquid delivery so that the dispensed beverage has a volume that is less than a threshold volume. In this case, the threshold volume may be a maximum volume determined by or set in the beverage machine 10 so that a suitable beverage is formed once the dispensed beverage is diluted with ice water. In other cases, further input may be required or permitted, e.g., one of the buttons 141-144 must be pressed to select a desired beverage volume (e.g., button 141 to select a 12 ounce beverage). The beverage machine may indicate which of the buttons 141-144 or 146 has been selected by presenting the selected button with a steady indicator light or other suitable indication for the user (such as displaying a volume number on a numeric display and/or displaying “iced” on a display). Upon pressing one of the buttons 141-144 to select the beverage volume, the beverage machine 10 may start an automated beverage dispensing operation that requires no further input from a user to complete, which may include heating water in a hot water tank to a desired level, and then delivering the heated water or other precursor liquid to the brew chamber 15 at a suitable flow rate and/or volume to mix with the beverage material and form a beverage that is dispensed into the user's cup 2. As an example, the beverage machine 10 may dispense a volume of beverage that is less than the volume selected by one of the buttons 141-144, e.g., so that a finished volume of beverage is formed equal to the selected (threshold) volume once the dispensed beverage is diluted with ice water.

In some other embodiments, after selecting a desired beverage volume by pressing one of the buttons 141-144, the user may have to press another button, such as a “start” button 145, to cause the beverage machine to start the beverage dispensing process (or brew cycle). For example, after one of the buttons 141-144 is pressed to select a beverage volume, the button 145 may flash indicating that the user must press the button 145 to start the automated dispensing operation. As mentioned above, the user may press the “iced” button 146 before or after the start button 145 (or before or after pressing a volume button 141-144) to select dispensing of an iced beverage. If the iced button 146 is pressed after the dispensing operation is started, e.g., after the start button 145 is pressed, the beverage machine may adjust operation to effect dispensing of an iced beverage. Thus, in some embodiments, a user need not press the iced button 146 or otherwise provide input to the machine 10 before a dispensing operation has begun to cause dispensing suitable for an iced beverage. Where the user provides input to indicate formation of an iced beverage after a dispensing operation has begun, the machine 10 may take whatever steps it can to attempt to dispense beverage to form the desired iced beverage. For example, where a lowered flow rate is used throughout a brew cycle to dispense an iced beverage, the machine 10 may immediately adjust to the appropriate flow rate upon receipt of the user's iced beverage input. Where a volume of dispensed beverage is adjusted for an iced beverage, the machine 10 may adjust liquid delivery to best achieve the desired beverage volume.

Exactly how the beverage machine 10 adjusts operation to effect the adjusted beverage volume and/or flow rate provided during the automated dispensing operation may depend on the liquid precursor supply components (such as pumps, flow meters, etc.) that the beverage machine 10 includes, as well as other conditions. For example, if the beverage machine 10 employs a pump and flow meter to detect an amount of precursor liquid delivered by the pump to the brew chamber 15, the beverage machine 10 may simply change the flow meter-detected volume at which the pump is shut down to stop liquid delivery so as to cause dispensing of a suitable beverage volume. If the beverage machine 10 operates by filling a hot water tank to a selected beverage volume and then delivering the volume to the brew chamber 15, the beverage machine 10 may add more liquid to the tank (in the case of an increase in selected beverage volume) or remove liquid from the tank or deliver less of the liquid in the tank (in the case of a decrease in selected beverage volume). In other embodiments, the beverage machine 10 may include an outlet valve that can stop dispensing to a user's cup when an appropriate volume of beverage has been dispensed for an iced beverage selection. In cases where additional beverage is produced, but not desired based on the user's iced beverage selection during dispensing, the outlet valve may divert additional unwanted beverage to a drip tray or waste tank rather than delivering the beverage to the user's cup. Other details regarding system control for different embodiments are provided below.

As mentioned above, other brew parameters may be adjusted in response to a user's input to form an iced beverage. A temperature of the beverage may be adjusted during a dispensing process, whether to effect dispensing of an iced beverage or in response to a user's alternate input. For example, during dispensing of an iced beverage further heating or cooling of liquid used to form a beverage may be stopped at some point during dispensing and/or the beverage may be heated or cooled after it is formed by mixing of liquid with a beverage material. As an example, hot water may be mixed with coffee grounds to form a hot coffee beverage, which may be dispensed. During or before a dispensing operation, a user may press the iced button, which causes an adjustment to the beverage temperature. Alternately, the user may adjust the dispensed beverage temperature directly via the user interface 14, e.g., by indicating that the dispensed beverage should have a temperature of 40 degrees F. In response, the control circuit may cause the hot coffee beverage to be chilled (e.g., by flowing over evaporator coils of a refrigeration system) before dispensing and/or the beverage may be made using chilled or unheated water. In another embodiment, a user may adjust a beverage temperature from e.g., 197 degrees Fahrenheit to 192 degrees Fahrenheit, and the control circuit may control a flow rate of liquid and/or a heating element (e.g., in thermal communication with water in a heater tank or an in-line heater) used to heat the liquid to achieve the adjusted beverage temperature. In some cases, where beverage has already been dispensed into a user's cup and the user makes an adjustment to beverage parameters (such as by pressing the iced button or otherwise providing input to adjust brew parameters), the control circuit may calculate a remaining amount of beverage to be dispensed and a suitable temperature of the beverage remaining to be dispensed so that the final temperature of beverage in the user's cup is at or near the adjusted temperature set by the user.

In embodiments where dispensing to form an iced beverage involves whipping or where a user can adjust an amount of whipping of a beverage, the beverage machine may include a whipping element (e.g., a motor driven blade or blades to agitate the beverage to introduce air or other gas into the beverage) to froth or foam beverage while the beverage is being dispensed from the brew chamber or after dispensing. The control circuit may be arranged to automatically control the whipping element to operate in at least some automated dispensing operations, e.g., while dispensing a hot milk beverage used to form an iced cappuccino or latte beverage. However, the user may provide input to the control circuit, such as by pressing the iced button or issuing a voice command, to terminate or start whipping at any point during or before the dispensing process. For example, a user may determine that no whipping of a milk beverage is desired at all and thus prevent any whipping. Or the user may determine that an amount of froth produced is sufficient and stop whipping prematurely in relation to when whipping would stop under automatic control. Similarly, the control circuit may typically not operate the whipping element in some processes, such as dispensing hot coffee, but a user may cause the control circuit to operate the whipping element to whip hot coffee if desired.

In embodiments where dispensing to form an iced beverage involves adjusting a time period over which the beverage is dispensed, the beverage machine may be arranged to stop, slow or speed beverage dispensing based on the user's input. For example, the beverage machine may include a valve at an outlet of the brew chamber that can be closed by the control circuit so as to prolong a steeping and/or dispensing time. In other embodiments, the control circuit may slow or speed a rate at which liquid is delivered to a brew chamber, or may adjust a size of a dispensing opening from the brew chamber to adjust the time period over which beverage is dispensed.

In embodiments where dispensing to form an iced beverage involves adjusting a flow rate at which liquid is delivered to the brew chamber, the beverage machine may adjust a speed of operation of a pump that delivers liquid to the brew chamber, may adjust a size of a throttling valve opening or other flow controller to adjust the liquid flow rate, may adjust a pressure or flow rate of air used to move liquid to the brew chamber (e.g., by adjusting a speed of operation of an air pump), and/or other techniques.

In embodiments where dispensing an iced beverage involves adjusting a pressure of liquid delivered to the brew chamber, the beverage machine may cause a pump to operate at a higher (or lower) pressure when delivering the liquid to the brew chamber, close or otherwise adjust a size of a dispensing opening from the brew chamber to cause a back pressure to build up (or be released) in the brew chamber, adjust a temperature in a boiler so as to increase or decrease a steam pressure in the boiler used to move liquid to the brew chamber, control whether or how pressure is vented from the brew chamber, or other techniques.

In embodiments where dispensing to form an iced beverage involves adjusting an amount of air or steam delivered to purge the brew chamber, the beverage machine may cause an air pump or liquid heater to operate or not depending on whether a user indicates whether a purge should occur. (Such indication may be pressing an iced button as in the embodiment above or otherwise indicating the desired to dispense an iced beverage, or by a user interacting with the user interface 14 to directly indicate a setting for purge operation.) For example, in the case of an air purge, a user may press a button or otherwise provide input to the control circuit before or after a dispensing operation has begun that causes the control circuit to run an air pump that delivers air to the brew chamber. Thus, an air purge may be employed where normal automatic operation would not cause an air purge to occur, and vice versa. In the case of a steam purge, user input may cause a heater to operate (or not) to create steam that is forced through the brew chamber.

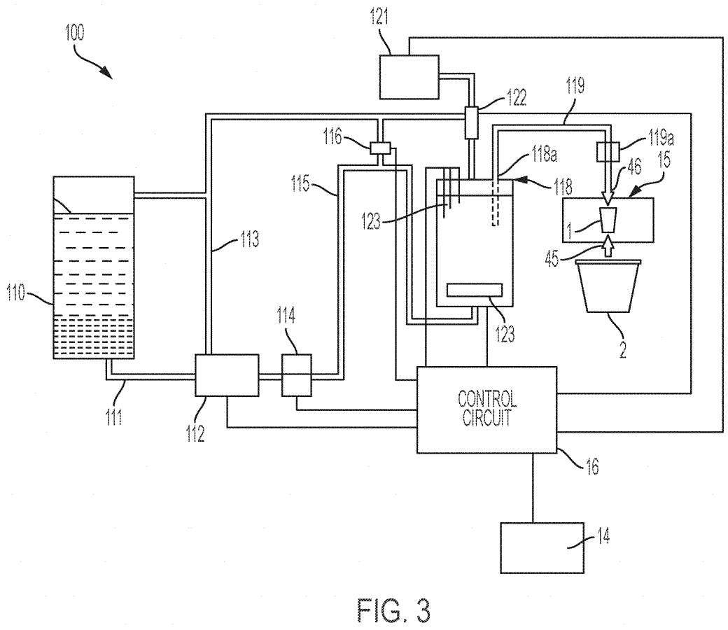

FIG. 3 shows a schematic block diagram of various components that may be included in a beverage forming apparatus 100 in one illustrative embodiment. Those of skill in the art will appreciate that a beverage forming apparatus 100 may be configured in a variety of different ways, and thus aspects of the invention should not be narrowly interpreted as relating only to one type of beverage forming apparatus. Water or other liquid may be provided to a cartridge 1 in a brew chamber 15 (in FIGS. 1 and 2 including the cartridge holder 3 and cover 4) or to another beverage outlet by a liquid supply that, in this embodiment includes a storage tank 110, a supply conduit 111 fluidly connecting the storage tank 110 to an inlet of a pump 112 (such as a centrifugal pump, piston pump, solenoid pump, diaphragm pump, etc.), and a pump conduit 115 that is fluidly connected between the outlet of the pump 112 and a liquid inlet of the heater tank 118. This embodiment includes other optional features, such as a check valve 114 or other flow controller (such as an electronically-controlled valve) that can prevent backflow in the pump conduit 115 from the tank 118 to the pump 112 or stop flow from the pump 112 to the tank 118, an optional pump conduit vent 116, which may include a controllable valve or fixed orifice, that allows a siphon in the pump conduit 115 to be broken as necessary, or a pressure relief valve that may open to vent the pump conduit 115 in the case of pressure over a threshold level. A priming conduit 113 may be fluidly connected to the pump 112 to allow the pump 112 to be primed by venting the pump 112, if needed. In other arrangements, the conduit 113 may provide air to the pump 112 to allow the pump 112 to pump air through the conduit 115 and to the heater tank 118, e.g., to purge the conduit 115, heater tank 118 and/or other conduits downstream of the heater tank 118. In such a case, the conduit 113 may include a valve that can be opened to permit air flow to the pump 112, and/or a valve to control water flow from the storage tank 110.

Operation of the water pump 112 and other components of the apparatus 100 may be controlled by a control circuit 16, e.g., which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 14), communication buses or other links, a display, switches, relays, triacs, or other components necessary to perform desired input/output or other functions. As discussed above, the user interface 14 may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

The heater tank 118 may be provided with a desired amount of liquid by any suitable technique, such as running the pump 112 for a predetermined time, detecting a flow rate or volume of liquid passing through the pump conduit 115 (e.g., at the flow controller 114 which may include a flow meter), operating the pump 112 for a desired number of cycles (such as where the pump is arranged to deliver a known volume of liquid for each cycle, such as for each revolution of a pump shaft), or using any other viable technique. Alternately, the heater tank 118 may be a flow through heater that heats water as it moves through the tank 118. At an initial operation or filling of the heater tank 118, the control circuit 16 may detect that the heater tank 118 is completely filled when a pressure sensor (not shown) detects a rise in pressure indicating that the water has reached the top of the heater tank 118, when a conductive probe 123 detects the presence of liquid in an upper portion of the tank 118, when an optical sensor detects a presence of liquid in the tank conduit 119, and others. Alternately, the control circuit 16 may not detect whether the tank 118 is filled or not, and simply assume that the tank 118 is filled once a first fill operation is completed, e.g., by operating the pump 112 for a time or number of cycles that is known to fill the tank 118.

Water in the tank 118 may be heated by way of a heating element 123 whose operation is controlled by the control circuit 16 using input from a temperature sensor or other suitable input. Water in the heater tank 118 may be dispensed via the heater tank conduit 119 to the brew chamber 15 or other beverage forming station or outlet. Liquid may be discharged from the heater tank 118 by the pump 112 operating to force additional unheated liquid into the tank 118, thereby displacing water out of the tank 118 and to the brew chamber 15. A flow sensor or other suitable device may be used to determine the amount of liquid delivered to the tank 118, and thus the amount of liquid delivered to the brew chamber 15. Alternately, the pump 112 may be a piston-type, diaphragm-type or other pump arranged such that a known volume of liquid may be delivered from the pump 112 to the tank 118, thus causing the same known volume to be delivered to the brew chamber 15. Thus, a specified volume of liquid may be delivered to the brew chamber 15 by operating the pump 112 to deliver the specified volume of liquid to the tank 118, e.g., a diaphragm pump may deliver 5 ml for each pump stroke, and thus 100 ml of liquid may be delivered to the tank 118 by operating the pump through 20 pump cycles (e.g., pump strokes or revolutions of a pump shaft). Liquid may be introduced into the cartridge 1 at any suitable pressure, e.g., 1-2 psi or higher, and the pressure may be adjustable by the control circuit 16. Although in this embodiment the tank conduit 119 is shown as connected simply to the top of the tank 118 at an outlet of the tank 118 without extending into the tank at all, the conduit 119 could be arranged in other suitable ways. The outlet of the heater tank 118 could be arranged at an extreme top of the tank 118, or in other ways in other embodiments, e.g., at the top of the tank 118 but below the extreme top portion of the tank 118, or at a location between the top and bottom of the tank 118 such as where the air pump 121 is used to move water from the tank 118 to the brew chamber 15 like that shown in FIG. 1 of U.S. Pat. No. 7,398,726. The tank conduit 119 may include a check valve 119a, solenoid valve or other flow controller, e.g., to help prevent backflow in the tank conduit 119 from the brew chamber 15 to the tank 118 and/or to prevent flow from the tank 118 to the brew chamber 15.

The brew chamber 15 may include any beverage making ingredient or material, such as ground coffee, tea, a flavored drink mix, or other beverage medium, e.g., contained in a cartridge 1 or not. Alternately, the brew chamber 15 may function simply as an outlet for heated water, e.g., where a beverage medium is contained in a user's cup 2. Once liquid delivery by the pump 112 to the tank 118 is complete, an air pump 121 may be operated to force air into the top of the tank 118 and/or into the conduit 119 to purge a top portion of the tank 118, the conduit 119 and/or cartridge 1 of liquid, at least to some extent. A valve 122 may be used to control air flow into and/or out of the tank 118.

While in this illustrative embodiment, a liquid supply system arranged to provide liquid to a beverage outlet (at the brew chamber 15) may include a pump 112, storage tank 110 and other components, these components are not necessarily required and/or other components may be included. For example, a check valve 114, flow meter, vent valve 116 (e.g., to help prevent the formation of a siphon), etc., may or may not be included with the liquid supply. Alternately, other mechanisms for providing liquid may be used, such as by gravity flow of liquid, flow forced by air pressure, or other motive force to move liquid from a storage tank 110, flow of liquid from a plumbed or other “city water” supply, and others.

For those systems employing a cartridge 1, once a cartridge is located in the brew chamber 15 in the closed position, the beverage forming system 100 may use the cartridge 1 to form a beverage. For example, one or more inlet needles 46 associated with the cover 4 or other part of the system 100 may pierce the cartridge 1 (e.g., a lid of the cartridge) so as to inject heated water or other liquid into the cartridge 1. The injected liquid may form the desired beverage or a beverage precursor by mixing with beverage material in the cartridge 1. The cover 4, cartridge holder 3 or other portion of the system 100 may also include one or more outlet needles 45 or other elements to puncture or pierce the cartridge 1 at an outlet side to permit the formed beverage to exit the cartridge 1. Other inlet/outlet piercing arrangements are possible, such as multiple needles, a shower head, a non-hollow needle, a cone, a pyramid, a knife, a blade, etc. In another arrangement, a beverage machine may include a piercing element (such as a spike) that forms an opening and thereafter a second inlet element (such as a tube) may pass through the formed hole to introduce liquid into (or conduct liquid out of) the container. In other embodiments, a lid or other portion of a cartridge may be pierced, or otherwise effectively opened for flow, by introducing pressure at an exterior of the lid. For example, a water inlet may be pressed and sealed to the lid exterior and water pressure introduced at the site. The water pressure may cause the lid to be pierced or otherwise opened to allow flow into the cartridge 1. In another arrangement, the cartridge lid may include a valve, conduit or other structure that opens when exposed to a suitable pressure and/or when mated with a water inlet tube or other structure. As with the inlet piercing arrangement, the outlet piercing arrangement may be varied in any suitable way. Thus, the outlet piercing element 45 may include one or more hollow or solid needles, knives, blades, tubes, and so on. Alternately, the cartridge 1 may include a valve, septum or other element that opens to permit beverage to exit when liquid is introduced into the cartridge, but otherwise remains closed (e.g., to protect the beverage medium from external conditions such as oxygen, moisture or others). In such a case, no piercing element for forming the outlet opening is necessarily required although may be used, e.g., to allow the valve or other element to open. Also, in this illustrative embodiment the piercing element 45 remains in place to receive beverage as it exits the opening formed in the cartridge. However, in other embodiments, the piercing element 45 may withdraw after forming an opening, allowing beverage to exit the opening and be received without the piercing element 45 being extended into the cartridge 1. Other arrangements for a beverage outlet are possible however, e.g., the cartridge may have a permeable portion that allows beverage to exit cartridge 1. Also, there is no requirement that an inlet and/or an outlet pierce a cartridge to provide liquid to, or receive beverage from, a cartridge. Instead, communication with a cartridge may be performed using any suitable ports or other features.

With a beverage cartridge 1 provided in the brew chamber 15 or beverage material (if used) otherwise provided with the brew chamber 15, the control circuit 16 may operate in different ways to dispense a beverage. In some embodiments, the control circuit 16 may automatically select one or more brew parameters for automatically controlling the liquid supply and liquid conditioner portions to dispense a beverage during a dispensing operation. For example, the control circuit 16 may select default values for parameters such as a beverage volume, beverage temperature, whether beverage frothing or whipping will be employed, a beverage dispense time or speed, a precursor liquid flow rate, a precursor liquid pressure, whether beverage chilling will be employed, whether brew chamber air or steam purge will be employed, whether beverage material pre-wet or pulse-type brewing will be employed and if so time periods between liquid delivery, and others. Such parameters may be automatically determined in different ways, such as by reading parameter values from an information element (such as an RFID tag) on a cartridge 1, receiving input from a user via a user interface 14 such as by the user pressing an iced button or otherwise indicating the desire to dispense an iced beverage, by employing default values stored in a memory of the control circuit 16, and/or by a combination of such techniques or others. In some cases, the control circuit 16 may begin a dispensing operation once the brew parameter values are set, or in response to additional user input such as the user pressing a brew start button, e.g., the button 145 in FIG. 2. In one example, a user may press one of the beverage volume buttons 141-144 in FIG. 2 to select a beverage volume, press the iced button 146, and then press a brew start button 145 to cause the control circuit 16 to start an automated dispensing operation to dispense an iced beverage. Parameters used to dispense an iced beverage may be set by default by the control circuit 16 and/or by input from the user. For example, other brew parameters such as beverage temperature, etc. may be automatically selected by the control circuit 16 using default values unless the user provides additional input to adjust those values.

The control circuit 16 may execute an automated dispensing operation (in this example in response to depression of the start button 145) in different ways since dispensing processes may include different steps which may be performed in series and/or in parallel. For example, in some embodiments the heater tank 118 may store a volume of pre-heated water such that the control circuit 16 may immediately control the pump 112 to deliver additional water to the tank 118, thereby causing the flow of heated water from the tank 118 to the brew chamber 15 at the start of a dispensing operation. In other embodiments, water in the heater tank 118 may first need to be heated, and thus the control circuit 16 may first cause the heating element 123 to heat water in the tank 118, and then automatically start water delivery once heating is complete. Of course, these steps are relevant to the illustrative embodiment in FIGS. 1-3, and other beverage machine 10 configurations may involve other steps at part of an automated dispensing operation. For example, if the beverage machine 10 employs an inline or flow through heater as a heater tank 118, the control circuit 16 may cause a heating element of the inline heater to begin heating and then simultaneously or shortly thereafter begin causing water flow through the inline heater and to the brew chamber. Where no pump is used by the beverage machine 10, water flow may be caused by gravity, steam pressure in an inline heater, or other.

With water or other liquid sufficiently heated in the heater tank 118, the control circuit 16 may continue with the automated process of beverage dispensing by causing the pump 112 to deliver liquid to the tank 118, thereby delivering heated liquid to the brew chamber 15. The control circuit 16 may sense or otherwise keep track of a volume of liquid delivered to the brew chamber 15 so that the appropriate beverage volume can be dispensed. For example, the control circuit 16 may cause the pump 112 to operate a specified number of cycles where a particular volume of liquid is delivered by the pump 112 for each pump cycle. Alternately, a flow meter may be used by the control circuit 16 to detect a volume of liquid delivered to the brew chamber 15, or other techniques.

In accordance with aspects of the invention, the control circuit 16 may be arranged to receive user input, e.g., via the user interface 14, to cause the dispensing of an iced beverage. Such input may be received before a brew cycle has started, or after, i.e., while the control circuit 16 is executing an automated beverage dispensing operation. In response, the control circuit 16 may adjust operation of one or more brew parameters for portions of the liquid supply and/or liquid conditioner as needed to dispense the desired iced beverage. In this example, a user may depress one of the beverage volume buttons 141-144 to select a beverage volume and the iced button 146 to indicate that an iced beverage is to be dispensed. For example, the user may initially select a beverage volume of 12 ounces, which would normally cause the control circuit 16 to cause the liquid supply to deliver about 12 ounces of water to the brew chamber to cause dispensing of about 12 ounces of beverage. However, pressing of the iced button 146 may indicate to the control circuit 16 that the finished beverage volume after mixing with ice is to be 12 ounces. Thus, in response, the control circuit 16 may cause the pump 112 to deliver a volume of water to dispense a beverage of 8 ounces rather than the originally set 12 ounce volume, e.g., because the 8 ounce beverage is dispensed at a temperature that typically causes 4 ounces of melted ice water to be formed and mixed with the beverage in the user's cup. Other brew parameters may be adjusted in response to the iced beverage indication as well. For example, the control circuit 16 may normally cause the liquid supply to deliver water at a constant flow rate to the brew chamber to cause beverage dispensing. However, with an iced beverage indicated, the control circuit 16 may control the liquid supply to slow (or speed) the water flow rate in comparison to standard operation, may cause a pre-wetting operation to occur, may cause water to be delivered in intermittent portions to the brew chamber (so-called pulse brewing), adjust a pressure of the water or steam, and so on. As noted above, these adjustments to brew parameters to effect dispensing of an iced beverage may be done automatically and by default by the control circuit 16, and/or based on specific input from the user.

In cases where the user indicates the desire to make an iced beverage after dispensing has started, the control circuit 16 can adjust the liquid delivery to execute the corresponding adjusted beverage volume, if applicable. Using the example above, if a beverage volume of 12 ounces is originally set for a standard beverage and the user indicates a desire for an iced beverage after dispensing has started, if the beverage machine 10 has already dispensed more than 8 ounces when the user makes the iced beverage indication, the control circuit 16 may stop liquid delivery in an attempt to best comply with the changed beverage volume. The control circuit 16 may also display information regarding how much beverage was actually dispensed and/or provide an error message that indicates that the iced beverage could not be executed because of the late time of parameter change. Assuming the user has not made other changes to brew parameters, the control circuit 16 may employ other adjusted brew parameters consistent with an iced beverage as part of an automated dispensing operation, such as beverage whipping, air purge of the brew chamber, liquid pressure adjustment, etc.

Other liquid supply or liquid conditioner arrangements may require different techniques for complying with a user indicated iced beverage dispensing operation. For example, if the heater tank outlet 118a is located between the top and bottom of the tank 118 (e.g., as shown in dashed line in FIG. 3), liquid is not typically delivered to the brew chamber 15 by causing the pump 112 to deliver water to the tank 118 so as to force water to flow out of the tank into the conduit 119 and to the brew chamber 15. Instead, such systems typically fill the heater tank 118 to a desired level, e.g., as detected by one or more conductive probes 123 shown in FIG. 3 or other sensor arrangements, and once the heater tank 118 is filled to a desired level and the water heated, the air pump 121 is operated to force water to flow out of the outlet 118a and to the brew chamber 15. The volume of liquid delivered to the brew chamber is equal to the volume of liquid in the tank 118 that is between the outlet 118a and the fill level in the tank 118 at the start of water delivery. In this case, if a user indicates a desire for an iced beverage that effectively decreases the volume of beverage dispensed, the control circuit 16 may operate the air pump 121 so that liquid delivery stops before the liquid level reaches the level of the outlet 118a. A conductive probe 123 or other sensor, or a run time of the air pump 121 may be used to determine that a suitable volume equal to the adjusted volume has been delivered from the tank 118 in the case of a need to deliver a decreased beverage volume. If the user indicates a desire for an iced beverage while liquid is being delivered from the tank 118 to the brew chamber 15, the control circuit 16 may use similar techniques to achieve the adjusted beverage volume. For decreased volume delivery, the control circuit 16 can stop liquid delivery prior to the liquid level in the tank 118 reaching the outlet 118a, e.g., as sensed by one or more conductive probes or other sensors. For increased volume delivery, the control circuit 16 can cause the pump 112 to deliver additional liquid to the tank 118, either during dispensing from the tank 118 or after an initial volume of liquid is delivered from the tank 118 more liquid can be delivered by the pump 112 to the tank 118, and then from the tank 118 to the brew chamber 15.

The examples above relate to a user indicating an iced beverage is to be dispensed that causes a change in dispensed beverage volume, but other parameters may be changed instead or, or in addition to, a dispensed volume as discussed above. For example, dispensing an iced beverage in response to a user pressing the iced button 146 may cause the control circuit 16 to adjust a strength of the dispensed beverage. Adjusting a “strength” of a beverage may be performed in different ways, such as using additional beverage material to form a beverage than a standard amount, using less water to form a beverage than a standard amount, using a higher water or steam pressure to form a beverage than a standard level (e.g., espresso coffee is made using higher pressure water or steam than drip-type coffee), and others. In this illustrative embodiment, adjusting the “strength” of a coffee beverage is done by adjusting a flow rate of water to the brew chamber: a slower flow rate provides longer contact time between water and coffee grounds, thereby increasing a “strength” of the coffee beverage dispensed. Thus, as part of an automated beverage dispensing operation, such as the formation of a “normal” strength coffee beverage, the control circuit 16 may control the pump 112 to deliver water to the tank 118, and thus the brew chamber 15, at a particular flow rate. If, during the dispensing operation, the user depresses the iced button 146, the control circuit 16 may adjust the flow rate of liquid to the brew chamber 15 to be slower than normal, thereby increasing water contact time with the coffee grounds. The flow rate may be slowed in different ways, such as by having the pump continuously deliver water to the brew chamber 15 although at a slower flow rate than normal, or having the pump intermittently deliver water to the brew chamber 15. In some embodiments, the control circuit 16 may slow a water flow rate only while the user depresses the iced button 146, and use a faster flow rate if the user releases the button 146. In other arrangements, a single press and release of the button 146 may cause the control circuit 16 to use a slower or faster flow rate. For example, if the control circuit 16 begins a dispensing operation using a higher flow rate, and the user depresses the button 146, the control circuit 16 may switch to a lower flow rate and use the lower flow rate throughout the remainder of the dispensing operation.

It should be understood that other user input provided via a user interface 14 to adjust other parameters may cause similar adjustment in system control by the control circuit during an automated dispensing operation. If a user presses a button or otherwise provides an increased temperature parameter for the beverage, the control circuit 16 may cause a heating element to operate so as to increase the beverage temperature accordingly. If a user presses a “whipping” button during dispensing, the control system may cause a whipper element to froth or foam a beverage dispensed whereas the whipper element would not have otherwise been used. Other adjustments to system operation under automated control by the control circuit 16 during a dispensing operation may be made in response to user adjusted brew parameters.

While aspects of the invention may be used with any suitable cartridge, or no cartridge at all, some cartridges may include features that enhance the operation of a beverage forming system 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutraceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the invention are not limited in this respect.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage forming system comprising:
a liquid supply arranged to provide a liquid for forming a beverage;
a brew chamber arranged to hold a beverage material for mixing with the liquid to form a beverage;
a liquid conditioner arranged to heat or cool the liquid that is provided to the brew chamber; and
a control circuit arranged to control the liquid supply and the liquid conditioner to operate automatically according to one or more brew parameters during a dispensing operation to deliver heated or cooled liquid to the brew chamber to form the beverage, wherein the control circuit is arranged to control the liquid supply to provide liquid to the brew chamber to dispense a beverage having a volume less than or equal to a threshold volume and/or to provide the liquid at a flow rate less than a threshold flow rate in response to a user's input indicating the dispensed beverage is to be combined with ice.

2. The system of claim 1, wherein the control circuit includes a user interface arranged to receive the user's input indicating the dispensed beverage is to be combined with ice.

3. The system of claim 2, wherein the user interface includes a button touchable by a user to provide the user's input.

4. The system of claim 2, wherein the user interface includes a plurality of buttons that are each touchable by a user to indicate a corresponding final beverage volume, at least one of the beverage volumes corresponding to one of the plurality of buttons being greater than the threshold volume.

5. The system of claim 1, wherein the threshold volume is 8 ounces or less.

6. The system of claim 1, wherein the control circuit is arranged to control the liquid supply to provide liquid to the brew chamber to form a dispensed beverage having a volume equal to a default volume in the absence of user input to define a beverage volume, and wherein the default volume is larger than the threshold volume.

7. The system of claim 1, wherein the control circuit is arranged to change operation of the liquid supply in response to receipt of the user's input during a beverage dispensing operation indicating the beverage is to be combined with ice.

8. The system of claim 7, wherein the control circuit is arranged to control the liquid supply to provide a volume of liquid to the brew chamber to form a dispensed beverage having a volume different from volume determined at a start of the dispensing operation.

9. The system of claim 1, wherein the control circuit is arranged to control the liquid supply or the liquid conditioner to provide liquid at a first temperature during a first portion of a dispensing operation and to provide liquid at a second temperature different from the first temperature during a second portion of the dispensing operation that is after the first portion in response to a user's input indicating the beverage is to be combined with ice.

10. The system of claim 9, wherein the second temperature is lower than the first temperature.

11. The system of claim 9, the control circuit is arranged to control the liquid conditioner to provide liquid at a first temperature during a first portion of a dispensing operation and to provide liquid at a second temperature different from the first temperature during a second portion of the dispensing operation.

12. The system of claim 1, wherein the liquid supply includes a pump that is controllable to provide water at different flow rates to the brew chamber.

13. The system of claim 12, wherein the liquid supply includes a cold water reservoir fluidly coupled to an input of the pump.

14. The system of claim 13, wherein the liquid conditioner includes a heater tank having an inlet coupled to an outlet of the pump and arranged to receive liquid provided by the pump, the heater tank including a heating element arranged to heat liquid in the heater tank.

15. The system of claim 14, wherein an outlet of the heater tank is fluidly coupled to an inlet of the brew chamber.

16. The system of claim 1, wherein the control circuit includes a sensor arranged to detect a characteristic of a beverage material in the brew chamber and the control circuit is arranged to control the liquid supply to provide liquid to the brew chamber to form a beverage having a volume equal to or less than the threshold volume and to provide the liquid at a flow rate less than the threshold flow rate in response to the detected characteristic of the beverage material.

17. The system of claim 16, wherein the characteristic of the beverage material is represented by machine readable information on a capsule containing the beverage material.

18. The system of claim 1, wherein the control circuit includes a user interface arranged to receive the user's input indicating the dispensed beverage is to be combined with ice and to receive input from the user to indicate a final beverage volume, and wherein the control circuit is arranged to control the liquid supply to provide liquid to the brew chamber to dispense the beverage having a volume less than the final beverage volume.

19. The system of claim 1, wherein the flow rate less than a threshold rate comprises a first flow rate, and the control circuit is arranged to control the liquid supply to provide liquid at the first flow rate during a first portion of a dispensing operation and to provide liquid at a second flow rate different from the first flow rate during a second portion of the dispensing operation that is after the first portion in response to a user's input indicating the beverage is to be combined with ice.

20. The system of claim 19, wherein the first flow rate is slower than the second flow rate.

21. The system of claim 9, wherein the flow rate less than a threshold flow rate comprises a first flow rate, and wherein the control circuit is arranged to control the liquid supply to provide liquid at a first flow rate during the first portion of the dispensing operation and to provide liquid at a second flow rate different from the first flow rate during the second portion of the dispensing operation that is after the first portion in response to a user's input indicating the beverage is to be combined with ice.

22. The system of claim 21, wherein the first temperature is higher than the second temperature, and the first flow rate is slower than the second flow rate.

23. A beverage forming system comprising:
a liquid supply arranged to provide a liquid for forming a beverage;
a brew chamber arranged to hold a beverage material for mixing with the liquid to form a beverage;
a liquid conditioner arranged to heat or cool the liquid that is provided to the brew chamber; and
a control circuit arranged to control the liquid supply and the liquid conditioner to operate automatically according to one or more brew parameters during a dispensing operation to deliver heated or cooled liquid to the brew chamber to form the beverage, wherein the control circuit is arranged to adjust one or more brew parameters used for the dispensing operation in response to a user's input indicating the dispensed beverage is to be combined with ice.

24-32. (canceled)
